(19) United States
(12) Patent Application Publication
(10) Pub. No.: US 2022/0283552 A1
(43) Pub. Date: Sep. 8, 2022

(54) Input Module and Method for Providing a Predicted Binary Process Signal

(71) Applicant: Siemens Aktiengesellschaft, Muenchen (DE)

(72) Inventor: Thomas GROSCH, Roßtal (DE)

(21) Appl. No.: 17/687,920

(22) Filed: Mar. 7, 2022

(30) Foreign Application Priority Data
Mar. 8, 2021 (EP) 21161276

(51) Int. Cl. G05B 13/02

(52) U.S. Cl. CPC G05B 13/026; G05B 13/021; G05B 13/027

(57) ABSTRACT

An input module and method for providing a predicted binary process signal, wherein in order to compensate for a signal delay for a binary process signal, further process signals of further sensors are temporarily stored for a predeterminable interval, and during a learning phase, at a switching moment, i.e., the moment at which the binary process signal indicates a first edge change from logical zero to logical one or a second edge change from logical one to logical zero, a neural network is supplied with the temporarily stored values of the process signals at a learning moment, which is produced from the switching moment minus a prediction interval, as a stimulating input signal pattern.

### BACKGROUND OF THE INVENTION

1. Field of the Invention

The invention relates to an input module configured to connect a first sensor, to acquire a binary process signal of the first sensor, and to acquire further process signals an relates to a method for providing a predicted binary process signal of a first sensor for an automation controller, which controls an industrial process, where an input module acquires further process signals of further sensors in addition to the binary process signal to be predicted of the first sensor.

Binary process signals are, for example, feedback signals of sensors from a controlled or regulated system relating to the states of the control variables, e.g., a switch position (on/off), a valve position (open/closed) or a movement state of a motor (rotating/stationary).

A production line or a movement of a drive is controlled, for example.

A flow rate of a medium through a pipe, a fill level of a liquid in a container or a rotational speed or torque of an electric motor is regulated, for example.

Control and regulation systems of this kind are used in process control systems, for example. Process control systems are used to automate processes in technical plants. The automated processes may, for example, involve process- engineering or production-engineering processes or processes for generating or distributing electrical energy.

2. Description of the Related Art

Process control systems are usually structured in a hierarchical manner by way of multiple levels (see, e.g., EP 3 125 053 B1). At a lowermost level, i.e., the “field level”, the states of the technical process are acquired via field devices formed as sensors (e.g., pressure transducer, temperature sensor, fill level sensor, flow rate sensor) or the process is influenced in a targeted manner via field devices embodied as actuators (e.g., positioner for regulating valves).

Above this level lies a control and/or regulation level with control and/or regulation facilities, in which a processing unit (CPU—central processing unit), as a component of a programmable logic controller, usually performs field-adjacent control and/or regulation functions in real time where possible, where they receive values of variables of the process from the sensors as input variables and submit them as output variables, e.g., commands, to the actuators.

At the process control level, which in turn lies thereabove, a higher-level control and regulation takes place in control computers, where an operator system consisting of one or more operator stations enables the operator control and monitoring of the process by way of the operating personnel of the plant.

An exchange of data between the field devices, e.g., input modules, and the processing unit of the programmable logic controller usually occurs via a field bus, such as PROFIBUS DP or PROFINET. As the field devices themselves often do not have a corresponding field bus connection, they are linked to the digital field bus via decentralized peripheral stations. A peripheral station usually consists of an interface module (header module) for connecting to the digital field bus and a number of peripheral modules (primarily digital and analog input and output units) for connecting the field devices. In this context, each input or output unit may only have a single so-called “channel” for connecting a single field device. It may also, however, have a plurality of channels for connecting a plurality of field devices (this is the usual case, e.g., 8, 16 or 32).

Usually, in this context the peripheral module is located immediately on site in the field by the field devices, while the programmable logic controller is located at a central point of the plant. Highly future-oriented control and regulation concepts even provide a cloud-based control or regulation facility.

In a typical procedure, the values of the input variables provided by the input units of the peripheral modules are cyclically read in in succession, processed and values are generated for output variables. These values for the output variables are subsequently written into the output units.

For the process signals, it is disadvantageous that the (seemingly) “actual” values of the process signals provided by the input module that are present at the moment of the processing in the automation controller are already outdated and are no longer current. This delay acts as an (additional) dead time during the control or regulation. The reasons for this delay lie, for example, in: (i) the overall procedure of the signal conditioning in the input unit, e.g., analog-digital conversion and filtering, (ii) the transfer to a field bus controller via field buses which, in some cases, may be slow, (iii) the transfer from the field bus controller to the automation controller or processing unit, and (iv) delays due to the values of all or at least a group of input units first being read in before the processing.

This problem comes into effect particularly in automation controllers for process-engineering or production-engineering plants that are greatly spatially distributed, particularly in plants that may extend over many square kilometers, such as plants in the chemical industry, oil and gas industry, metal industry, mines, power plants, and/or traffic infrastructure (airports, tunnels).

In order to somewhat compensate for the poor(er) control and regulation quality due to outdated values, the processing cycles are shortened as an alternative.

The more frequently run cycle, however, places a strain on the processing unit in particular. Additionally, a higher transfer bandwidth is necessary.

Another approach is what is “clock synchronicity”, in which acquisition, processing and outputting occur with strict timing. The delay between acquisition and processing is not eliminated, but is deterministic. The disadvantages here are the elaborate project planning and the poor changeability during ongoing operation. Additionally, components are usually required which are specifically provided for this purpose and therefore are expensive.

### SUMMARY OF THE INVENTION

In view of the foregoing, it is an object of the invention to provide an input module and method for reducing the effects of delays between acquisition and processing.

This and other objects and advantages are achieved in accordance with the invention by a method for providing a predicted binary process signal of a first sensor for an automation controller, which controls an industrial process, where an input module acquires further process signals of further sensors in addition to the binary process signal to be predicted of the first sensor via which, from the process signals, a signal profile with its respective temporal assigned values is in each case temporarily stored for a predeterminable interval, and where, in order to compensate for a delay between an actual occurrence of the binary process signal at the first sensor and a subsequent processing in the automation controller, a learning phase is performed, where during the learning phase, at a switching moment, i.e., the moment at which the binary process signal indicates a first edge change from logical zero to logical one, or a second edge change from logical one to logical zero, the temporarily stored values of the signal profiles at a learning moment, which is produced from the switching moment minus a prediction interval, are supplied to a neural network as a stimulating input signal pattern, where the input signal pattern is assigned the corresponding edge change, and in an operating phase the further signal profiles are monitored such that current values from the signal profiles are supplied to the neural network as an input signal pattern to be evaluated and, if a learned input signal pattern corresponds with a supplied input signal pattern, then the associated edge change is made available to the automation controller as a predicted value for the binary process signal.

To this end, the predicted value preferably lies in the future by the prediction interval, where the prediction interval is set as a function of the delays between acquiring the variable and generating an output variable from the input variable.

The accuracy of the prediction decreases as the interval increases. Accordingly, the interval is preferably equal to or less than the sum of these delays. Advantageously, an optimum is set between processing as current values as possible (interval as large as possible) and accuracy of the prediction (interval as small as possible).

Advantageously, a method for pattern recognition from the field of artificial intelligence is used. In accordance with the invention, a pattern recognition of this kind is used for the prediction of binary signals. Usually, the sensors (binary and analog) in an automation plant are connected to the automation controller via a field bus. In an automation plant, it is also possible for there to be peripheral stations that consist of “header modules” and one or more “input modules”, which acquire the sensor signals and ultimately forward them to the automation controller via the field bus. One advantage of this method is that there is no need to create a dynamic model of a plant in order to predict a binary signal. An algorithm used does not require knowledge about the physical circumstances. The method can thus be applied in a generally valid manner.

It is furthermore advantageous if the monitoring in the operating phase is performed on the part of the input module or on the part of a peripheral module assigned to the input module, where from there the predicted binary process signal is forwarded to the automation controller via a field bus communication.

In a further embodiment of the method, during the operating phase, a real process signal is used, which occurs after the prediction at the switching moment, for the ongoing improvement of the prediction for a learning process that is continuing in the background.

Advantageously, the neural network is formed as a self-organizing map. Self-organizing maps, cocoon maps or cocoon networks refer to a kind of artificial neural network. They are an effective tool for data mining for an unsupervised learning method.

It is also an object of the invention to provide an input module, which is configured to connect a first sensor and to acquire a binary process signal of the first sensor. The input module is further configured to acquire further process signals, comprising a storage device configured to temporarily store a signal profile in each case from the process signal for a predeterminable interval, a learning device, having a neural network and a trigger device, configured to supply the neural network, at a switching moment, i.e., the moment at which the binary process signal indicates a first edge change from logical zero to logical one or a second edge change from logical one to logical zero, with the temporarily stored values of the signal profiles at a learning moment, which is produced from the switching moment minus a prediction interval, as a stimulating input signal pattern. The input module is further configured to assign the input signal pattern the corresponding edge change, where a monitoring device configured to monitor the further signal profiles such that current values from the signal profiles are supplied to the neural network as an input signal pattern to be evaluated and, if a learned input signal pattern corresponds with a supplied input signal pattern, the associated edge change is made available to the automation controller as a predicted value for the binary process signal.

Advantageously, the input module is formed with a field bus interface, where a transmitting device is present, which is configured to submit the prediction value with priority over other messages.

In a further embodiment of the input module, the learning device is further configured to operate in the background of the monitoring device and to use a real process signal, which occurs after the prediction at the switching moment, for the ongoing improvement of the prediction for a learning process that is continuing in the background.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The characteristics, features and advantages of this invention described above and also the manner in which these are achieved will be explained in a clearer and easier to understand way in conjunction with the description given below of an exemplary embodiment, which is explained in greater detail in conjunction with the drawings, in which:

FIG. 1 shows an illustration of the evaluation of the process signals over time;

FIG. 2 shows the process signals, shown one below the other, to ascertain an input signal pattern over time;

FIG. 3 shows an input module for acquiring process signals and for predicting a binary process signal;

FIG. 4 is a flowchart of the method in accordance with the invention.

### DETAILED DESCRIPTION OF THE EXEMPLARY EMBODIMENTS

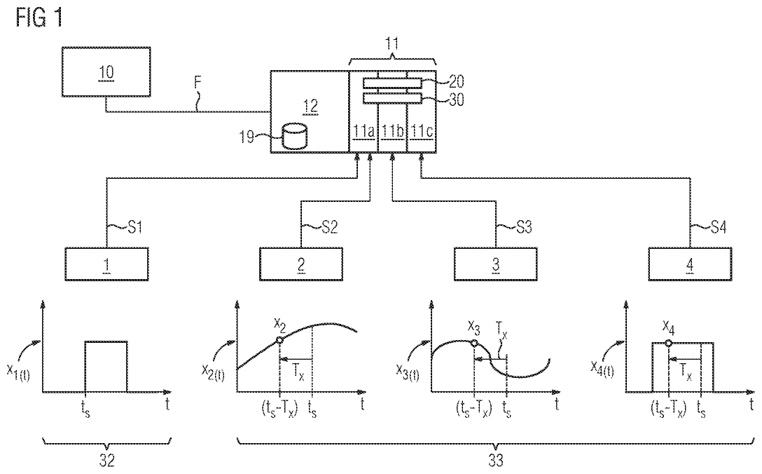

With reference to FIG. 1, an automation controller 10 is connected to a peripheral module 12 via a field bus F. The peripheral module 12 has an input module 11, which is divided into a first input module 11a, a second input module 11b and a third input module 11c. Connected to the first input module 11a is a first sensor 1, which delivers a first process signal S1. Additionally connected to the first input module 11a is a second sensor 2, which delivers a second process signal S2. Connected to the second input module 11b is a third sensor 3, which delivers a third process signal S3. Connected to the third input module 11c is a fourth sensor 4, which delivers a fourth process signal S4. A prediction is to be created for the first sensor 1 or the first process signal S1 thereof. To this end, the process signals S1, S2, S3, S4, which are each assigned a signal profile x₁₍ₜ₎,x₂₍ₜ₎,x₃₍ₜ₎,x₄₍ₜ₎ with its respective temporal assigned values x₁,x₂,x₃,x₄, are temporarily stored in the peripheral module 12 with a storage device 19 for a predeterminable interval tB.

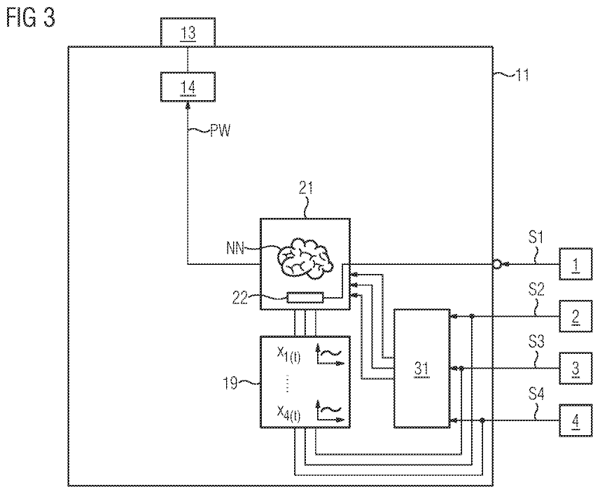

In order to compensate for a delay between an actual occurrence of the binary process signal S1 at the first sensor 1 and a subsequent processing in the automation controller 10, a learning phase 20 is performed. In the learning phase 20, at a switching moment ts, i.e., the moment at which the binary process signal S1 indicates a first edge change Fl from logical zero to logical one or a second edge change F2 from logical one to logical zero, the temporarily stored values x_{2(ts-Tx)},x_{3(ts-Tx)}, x_{4(ts-Tx)} of the signal profiles X₁₍ₜ₎,X₂₍ₜ₎,X₃₍ₜ₎,X₄₍ₜ₎ at a learning moment tₛ-Tₓ, which is produced from the switching moment tₛ minus a prediction interval Tₓ, are supplied to a neural network NN (see also FIG. 3) as a stimulating input signal pattern M1,...,M5, where the input signal pattern M1,...,M5 is additionally assigned the corresponding edge change F1 ,F2.

Following this, a backward consideration 33 into the past is performed for the learning phase for the signal profiles S2, S3, S4. In the first signal profile S1 to be predicted, a forward consideration 32 is performed for the prediction.

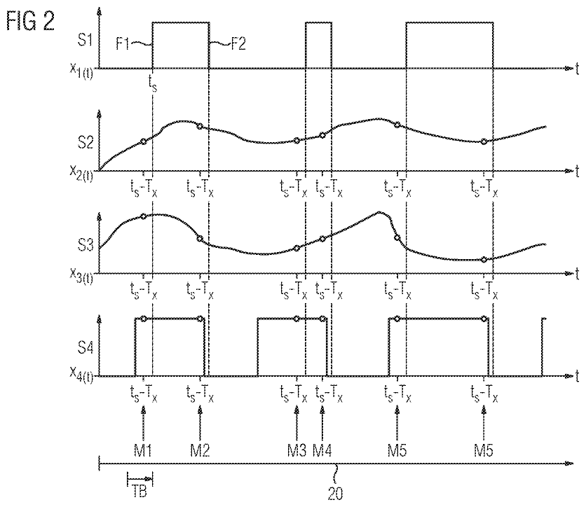

In FIG. 2, the process signals S1, S2, S3, S4 are shown one below the other. If, for the first process signal S1, a first edge change F1 occurs in the first signal profile x₁₍ₜ₎ at switching moment ts, then for the further process signals S2, S3, S4 a value from the past ts-Tx is in each case supplied to the neural network NN for a stimulating first input signal pattern M1 to be input. In the case of a further edge change, the removal of the past value is to be considered in a similar manner for the further input signal patterns M2, M3, M4, M5.

FIG. 3 shows an input module 11 configured for connecting a first sensor 1 and for acquiring a binary process signal S1 of the first sensor 1. The input module 11 is additionally configured to acquire further process signals S2, S3, S4. The input module 11 has a storage device 19, which is configured to temporarily store a signal profile x₁₍ₜ₎,x₂₍ₜ₎,x₃₍ₜ₎,x₄₍ₜ₎ from the process signals S1,S2,S3,S4 for a predeterminable interval TB.

In order to supply a neural network NN with input signal patterns M1,...,M5 in a learning phase 20, the input module 11 has a learning device 21. The learning device 21 additionally has a trigger device 22, which ensure that, at a switching moment ts, i.e., the moment at which the binary process signal S1 indicates a first edge change F1 from logical zero to logical one or a second edge change F1 from logical one to logical zero, the temporarily stored values x_{2(ts-Tx)},x_{3(ts-Tx)},x_{4(ts-Tx)} of the signal profiles x₁₍ₜ₎,x₂₍ₜ₎,x₃₍ₜ₎ at a learning moment tₛ-Tₓ, which is produced from the switching moment minus a prediction interval Tx, are supplied to the neural network NN as a stimulating input signal pattern M1,...,M5.

If the learning phase 20 is completed, a monitoring phase 30 is introduced, for which the input module 11 has a monitoring device 31, which is configured to monitor the further signal profiles x₂₍ₜ₎,x₃₍ₜ₎,x₄₍ₜ₎ such that current values x₂,x₃,x₄ from the signal profiles x₂₍ₜ₎,x₃₍ₜ₎, x₄₍ₜ₎ are supplied to the neural network NN as an input signal pattern M1,...,M5 to be evaluated and, if a learned input signal pattern M1,...,M5 corresponds with a supplied input signal pattern, then the associated edge change Fl ,F2 is made available to the automation controller 10 as a predicted value PW for the binary process signal S1 via a transmitting device 14 and a field bus interface 13.

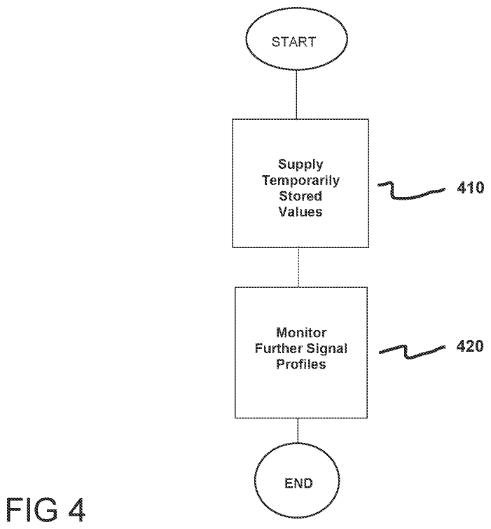

FIG. 4 is a flowchart of the method for providing a predicted binary process signal S1 of a first sensor 1 for an automation controller 10, which controls an industrial process, where an input module 11 acquires further process signals S2, S3, S4 of further sensors 2, 3, 4 in addition to the binary process signal S1 to be predicted of the first sensor 1, a signal profile x₁₍ₜ₎,x₂₍ₜ₎,x₃₍ₜ₎,x₄₍ₜ₎ from the process signals S1, S2, S3, S4 with a respective temporal assigned values x₁₍ₜ₎,x₂₍ₜ₎,x₃₍ₜ₎,x₄₍ₜ₎ are each temporarily stored for a predeterminable interval TB, and a learning phase 20 is performed to compensate for a delay between an actual occurrence of the binary process signal S1 at the first sensor 1 and a subsequent processing in the automation controller 10.

The method comprise supplying the temporarily stored values x2_{(ts-Tx)},x_{3(ts-Tx)}, x_{4(ts-Tx)} of the signal profiles x₂₍ₜ₎,x₃₍ₜ₎, x₄₍ₜ₎ at a learning moment tₛ-Tₓ, which is produced from the switching moment ts minus a prediction interval Tx to a neural network NN as a stimulating input signal pattern M1,...,M5, during the learning phase 20, at a switching moment ts, comprising a moment at which the binary process signal S1 indicates a first edge change F1 from logical zero to logical one or a second edge change F2 from logical one to logical zero, as indicated in step 410. Here, the input signal pattern M1,...,M5 is assigned the corresponding edge change F1, F2.

Next, the further signal profiles x₂₍ₜ₎,x₃₍ₜ₎,x₄₍ₜ₎ are monitored, during an operating phase 30, such a manner that current values x₂₍ₜ₎,x₃₍ₜ₎,x₄₍ₜ₎ from the signal profiles x₂₍ₜ₎,x₃₍ₜ₎,x₄₍ₜ₎ are supplied to the neural network NN as an input signal pattern M1,...,M5 to be evaluated and such that, if a learned input signal pattern M1,...,M5 corresponds with a supplied input signal pattern, then the associated edge change F1,F2 is made available to the automation controller 10 as a predicted value for the binary process signal S1, as indicated in step 420.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing a predicted binary process signal of a first sensor for an automation controller, which controls an industrial process, an input module acquiring further process signals of further sensors in addition to the binary process signal to be predicted of the first sensor, a signal profile from the process signals with a respective temporal assigned values each being temporarily stored for a predeterminable interval, and a learning phase being performed to compensate for a delay between an actual occurrence of the binary process signal at the first sensor and a subsequent processing in the automation controller, the method comprising:
supplying the temporarily stored values of the signal profiles at a learning moment, which is produced from the switching moment minus a prediction interval to a neural network as a stimulating input signal pattern, during the learning phase, at a switching moment, comprising a moment at which the binary process signal indicates a first edge change from logical zero to logical one or a second edge change from logical one to logical zero, the input signal pattern being assigned the corresponding edge change; and
monitoring, during an operating phase, the further signal profiles, such a manner that current values from the signal profiles are supplied to the neural network as an input signal pattern to be evaluated and such that, if a learned input signal pattern corresponds with a supplied input signal pattern, then the associated edge change is made available to the automation controller as a predicted value for the binary process signal.

2. The method as claimed in claim 1, wherein the monitoring in the operating phase is performed on a part of the input module or on a part of a peripheral module assigned to the input module; and wherein the predicted binary process signal is forwarded from the part of the input module or the part of the peripheral module to the automation controller via a field bus communication.

3. The method as claimed in claim 1, wherein a real process signal, which occurs after the prediction at the switching moment, is utilized for an ongoing improvement of the prediction for a learning process that is continuing in the background during the operating phase.

4. The method as claimed in claim 2, wherein a real process signal, which occurs after the prediction at the switching moment, is utilized for an ongoing improvement of the prediction for a learning process that is continuing in the background during the operating phase.

5. The method as claimed in claim 1, wherein the neural network is configured as a self-organizing map.

6. The method as claimed in claim 2, wherein the neural network is configured as a self-organizing map.

7. The method as claimed in claim 3, wherein the neural network is configured as a self-organizing map.

8. An input module configured to connect a first sensor, acquire a binary process signal of the first sensor, and to acquire further process signals, the input module comprising:
a storage device configured to temporarily store a signal profile from each process signal of the process signals for a predeterminable interval;
a learning device having a neural network and a trigger, said learning device being configured to supply the neural network, at a switching moment comprising a moment at which the binary process signal indicates a first edge change from logical zero to logical one or a second edge change from logical one to logical zero, with the temporarily stored values of the signal profiles at a learning moment, which is produced from the switching moment minus a prediction interval, as a stimulating input signal pattern, the learning device being further configured to assign the input signal pattern the corresponding edge change;
a monitoring device configured to monitor the further signal profiles such that current values from the signal profiles are supplied to the neural network as an input signal pattern to be evaluated and such that, if a learned input signal pattern corresponds with a supplied input signal pattern, then the associated edge change is made available to the automation controller as a predicted value for the binary process signal.

9. The input module as claimed in claim 8, further comprising:
a field bus interface;
a transmitter which is configured to submit the prediction value with priority over other messages.

10. The input module as claimed in claim 8, wherein the one learning device is further configured to operate in the background of the monitoring device and to utilize a real process signal, which occurs after the prediction at the switching moment, for ongoing improvement of the prediction for a learning process which is continuing in the background.

11. The input module as claimed in claim 9, wherein the one learning device is further configured to operate in the background of the monitoring device and to utilize a real process signal, which occurs after the prediction at the switching moment, for ongoing improvement of the prediction for a learning process which is continuing in the background.
